(19) United States
(12) Patent Application Publication
(10) Pub. No.: US 2009/0162023 A1
(43) Pub. Date: Jun. 25, 2009

(54) DIGITAL PHOTO FRAME WITH MENU OPTIONS SETTING FUNCTION AND METHOD OF SETTING THE MENU OPTIONS

(75) Inventors: XIAO-GUANG LI, Shenzhen City (CN); KUAN-HONG HSIEH, Tu-Cheng (TW)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 12/203,425

(22) Filed: Sep. 3, 2008

(30) Foreign Application Priority Data
Dec. 19, 2007 (CN) 200710125262.0

(51) Int. Cl. H04N 9/79; H04N 5/91; G06F 3/00

(52) U.S. Cl. 386/8; 386/95; 715/719; 715/727; 386/E05.001

(57) ABSTRACT

A method for setting menu options for a digital photo frame includes a memory configured for storing a plurality of multimedia files. The method further includes outputting a menu of at least one of a plurality of menu options, receiving inputs, determining current available system resources and available menu options associated with multimedia file in response to a selected operation, and generating a different menu on the menu to prevent system resource occupation. A digital photo frame with menu options setting function is also provided.

### BACKGROUND

1. Technical Field

The present invention relates to a digital photo frame with menu options setting function that can set menu options conveniently.

2. Description of Related Art

A typical digital photo frame may display photos, play music, and display a clock. When turned on, the typical digital photo frame displays a default user interface with different menu options corresponding to different functions. If a user wishes to modify the functions, the user needs to reset the menu options on the menu of the user interface. Currently, menu options settings are inconvenient to configure.

What is needed, therefore, is a digital photo frame that can overcome the above-described shortcoming.

### SUMMARY

A method for setting menu options for a digital photo frame includes a memory configured for storing a plurality of multimedia files. The method further includes outputting a menu of at least one of a plurality of menu options, receiving inputs, determining current available system resources and available menu options associated with multimedia file in response to a selected operation, and generating a different menu on the menu to prevent system resource occupation.

Other advantages and novel features will be drawn from the following detailed description with references to the attached drawings.

### BRIEF DESCRIPTION OF THE DRAWINGS

The components of the drawings are not necessarily drawn to scale, the emphasis instead being placed upon clearly illustrating the principles of the digital photo frame with menu options setting function. Moreover, in the drawings, like reference numerals designate corresponding parts throughout the several views.

FIG. 1 is an isometric view of a first embodiment of a digital photo frame shown in a display state, the digital photo frame including a memory capable of storing multimedia files.

FIG. 2 is a block diagram of a hardware infrastructure of the digital photo frame of FIG. 1.

FIG. 3 is a setting table showing relationships between multimedia files stored in the memory of the digital photo frame of FIG. 1.

FIG. 4 is a flowchart illustrating a play mode setting method implemented by the digital photo frame of FIG. 1.

FIG. 5 is an isometric view of a second embodiment of a digital photo frame showing a plurality of menu options.

FIG. 6 is a flowchart illustrating a play mode setting method implemented by the digital photo frame of FIG. 5 including steps 610 through 660.

FIG. 7 is a detailed flowchart of step 610 of the method in FIG. 6.

FIG. 8 is a detailed flowchart of step 650 of the method in FIG. 6.

FIGS. 9 and 10 are isometric views of the digital photo frame of FIG. 5 shown in display states.

### DETAILED DESCRIPTION OF THE EMBODIMENT

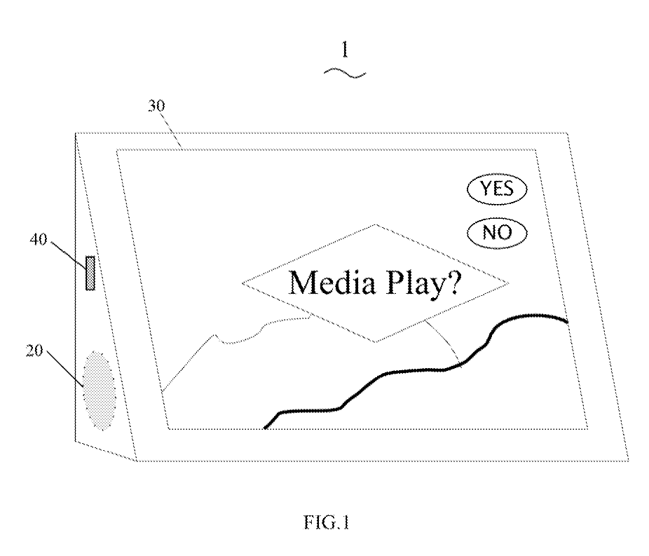

FIG. 1 is an isometric view of a first embodiment of a digital photo frame 1 shown in a display state. The digital photo frame 1 includes a display unit 30, a loudspeaker 20, and a memory card slot 40. The loudspeaker 20 is configured for outputting sound. The display unit 30 is configured for displaying images, texts, or a combination of images and text. The memory card slot 40 is configured for receiving memory cards.

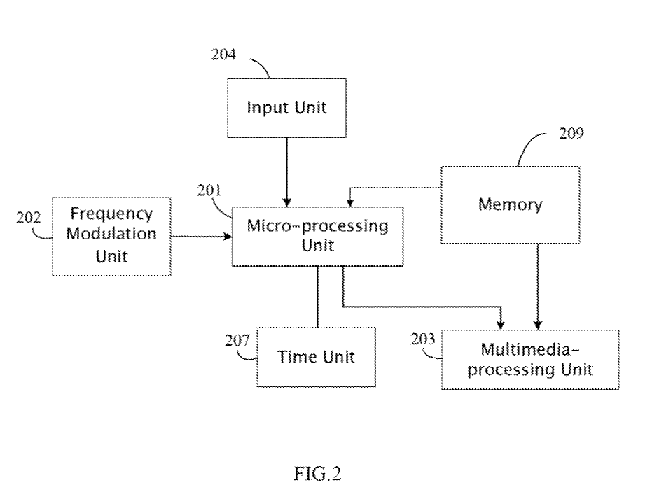

FIG. 2 is a block diagram of a hardware infrastructure of the digital photo frame 1. The digital photo frame 1 further includes a micro-processing unit 201, a frequency modulation unit 202, a multimedia-processing unit 203, an input unit 204, a time unit 207, and a memory 209. The micro-processing unit 201 is configured for controlling the multimedia-processing unit 203 to play multimedia files and outputting them via the display unit 30 and/or the loudspeaker 20. The frequency modulation unit 202 is configured for receiving radio signals. The input unit 204 is configured for receiving input from a user and providing the input to the micro-processing unit 201. The input unit 20 may be, for example, keys or touch-sensing devices. The time unit 207 is configured for supplying a system time to the digital photo frame 1.

The memory 209 is configured for storing the multimedia files, a plurality of different menu options and recording relationships associated with each menu option as shown in a type table and a setting table. The multimedia files may be video files, image files, and audio files. Each menu option corresponds to a different function, such as a video play function, an audio play function, an image display function, a radio play function, and a clock display function. For example, a video play menu option corresponds to the video play function. The type table shows the relationships between file types of the multimedia files and filename extensions associated with the file types. The setting table shows the relationships between menu options, file types, and system resource occupation to prevent system resource occupation conflicts.

The type table shows the filename extensions associated with each file type. For example, filename extensions corresponding to a video file include .avi, .rm, and .mp4, filename extensions corresponding to an audio file include .mp3 and .wma, and filename extensions corresponding to an image file include .jpg, .tif, and .bmp. It may be appreciated that the filename extensions corresponding to the video file, the audio file, and the image file may also correspond to other file types.

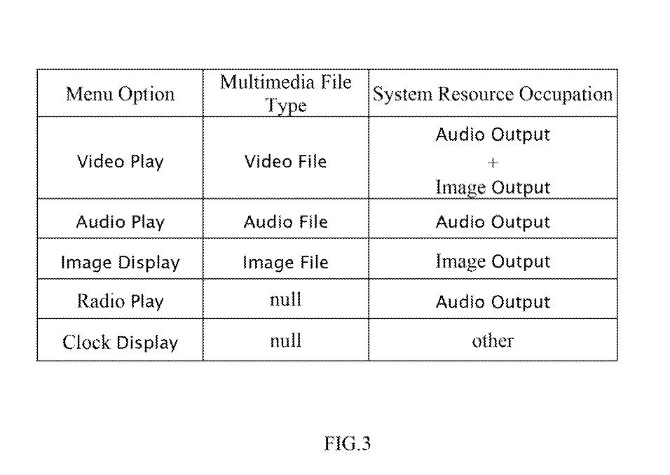

FIG. 3 is the setting table showing relationships between multimedia files stored in the memory 209. The digital photo frame 1 is capable of implementing video play, image display, audio play, radio play, and clock display. However, the digital photo frame 1 may not be capable of implementing all of these functions simultaneously due to system resource limitations. The setting table prevents system resource occupation conflicts. The setting table shows the menu options and file types associated with the system resources. The menu options column shows the menu options corresponding to functions of the digital photo frame 1, such as video play, audio play, image display, radio play, and clock display. The functions of video play, audio play, and image display are multimedia play functions. The multimedia file type column shows the file types that are played when performing the function. For example, when performing the video play function, a video file is played. The system resource occupation column shows system resources that are occupied when performing one of the functions. For example, when the digital photo frame 1 performs the video play function, the system resource of audio output and image output are occupied. When the digital photo frame 1 performs the image display function, the system resource of image output is occupied. When the digital photo frame 1 performs the audio play function or radio play function, the system resource of audio output is occupied. When the digital photo frame 1 performs the clock display function, no system resources are occupied. Therefore, if the video play function is running, the audio output and the image output are in use, so the audio play function, the image display function, and the radio play function cannot run simultaneously.

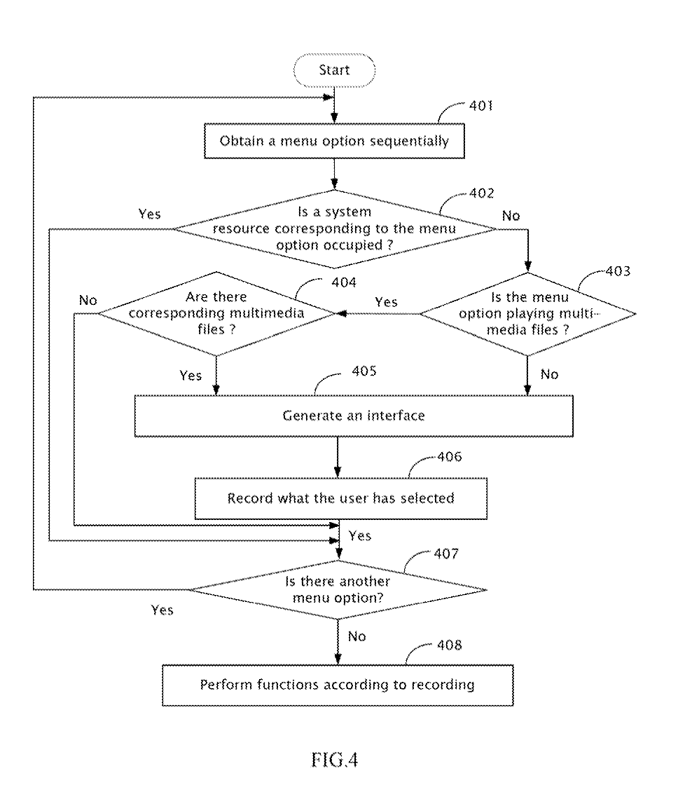

FIG. 4 is a flowchart illustrating a play mode setting method of a first embodiment of the digital photo frame 1. Depending on the embodiment, certain of the steps described below may be removed, others may be added, and the sequence of steps may be altered.

In a step 401, the micro-processing unit 201 obtains each of the menu options sequentially from a preset menu options table. The preset menu options table is stored in the memory 209 and stores priorities of all menu options corresponding to priorities of all functions. The preset menu options table may be preset by system default or based on previous selections such as putting the most selected menu options first.

Continuing to a decision step 402, the micro-processing unit 201 determines if the system resource needed to execute the multimedia file by the menu option is occupied. If the system resource needed is occupied, the method continues to a decision step 407. If the system resource needed is not occupied, the method continues to a decision step 403.

In the decision step 403, the micro-processing unit 201 determines if the function corresponding to the menu option is playing a multimedia file. If the function corresponding to the menu option is not playing a multimedia file, the method continues to a step 405. If the function is playing a multimedia file, the method continues to a decision step 404.

In the decision step 404, the micro-processing unit 201 determines if there are multimedia files in the memory 209 that correspond to the type table. If there are multimedia files in the memory 209, the method continues to the step 405. If there are no multimedia files in the memory 209, the method continues to the decision step 407.

In the step 405, the micro-processing unit 201 generates an interface including a plurality of menus. Each menu displays menu options corresponding to one multimedia play function. The menus are displayed sequentially according to the preset menu options table, such as that shown in FIG. 1.

Moving to a step 406, the micro-processing unit 201 records a selected menu option from a user of the digital photo frame 1 via the input unit 204.

In the decision step 407, the micro-processing unit 201 determines if there is another menu option in the preset menu options table. If there is another menu option, the method continues to the step 401 and repeats the procedure for another menu option. If there is not another menu option, the method continues to a step 408, and the digital photo frame 1 performs the function according to what the micro-processing unit 201 has recorded.

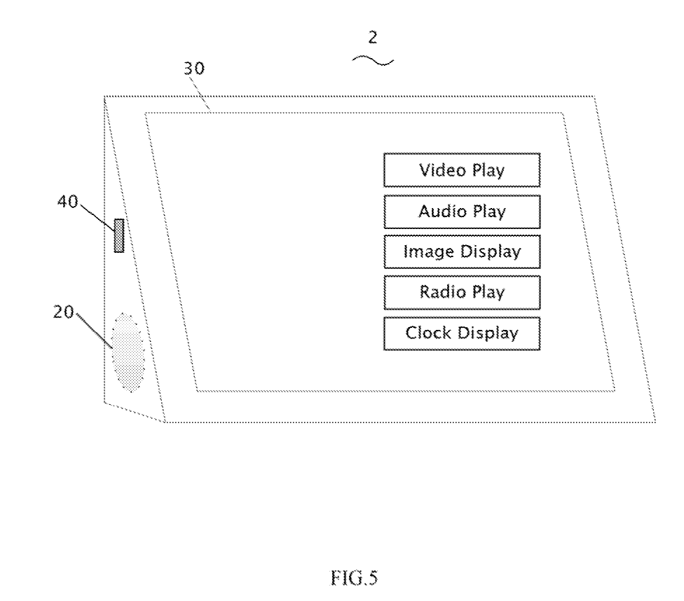

FIG. 5 is an isometric view of a second embodiment of a digital photo frame 2 showing a menu of menu options. The second embodiment of a digital photo frame 2 is similar to the first embodiment of the digital photo frame 1 of FIG. 1, except that, among other things, the menu of the first embodiment displays only one menu option and the second embodiment displays the menu of menu options according to the multimedia files stored in the memory 209.

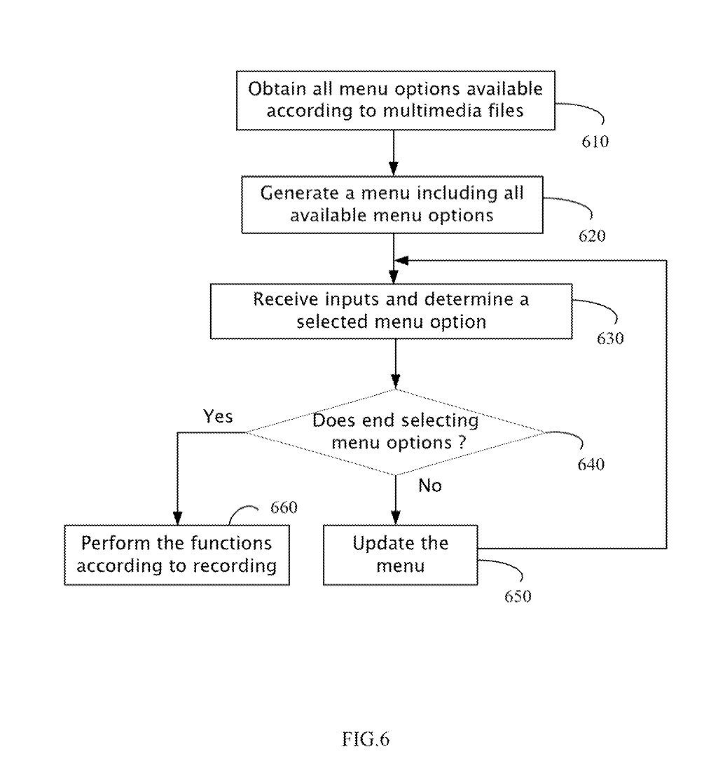

FIG. 6 is a flowchart illustrating a play mode setting method implemented by the digital photo frame 2 of FIG. 5. Depending on the embodiment, certain of the steps described below may be removed, others may be added, and the sequence of steps may be altered.

In a step 610, the micro-processing unit 201 obtains all available menu options according to the multimedia files in the memory 209.

Continuing to a step 620, the micro-processing unit 201 generates a menu of menu options as shown in FIG. 5 and displays the menu on the display unit 30.

Moving to a step 630, the micro-processing unit 201 records the selected menu option according to inputs from the input unit 204, and the corresponding system resource needed.

In a decision step 640, the micro-processing unit 201 determines whether to end the selection of menu options. In one embodiment, the selection of menu options may be ended by user input. If the micro-processing unit 201 determines not to end the selection of menu options, the method continues to a step 650. If the micro-processing unit 201 determines to end the selection of menu options, the method continues to a step 660.

In the step 650, the digital photo frame 1 updates the menu according to the menu options the user has selected.

In the step 660, the digital photo frame 2 performs the functions according to what the micro-processing unit 201 had recorded.

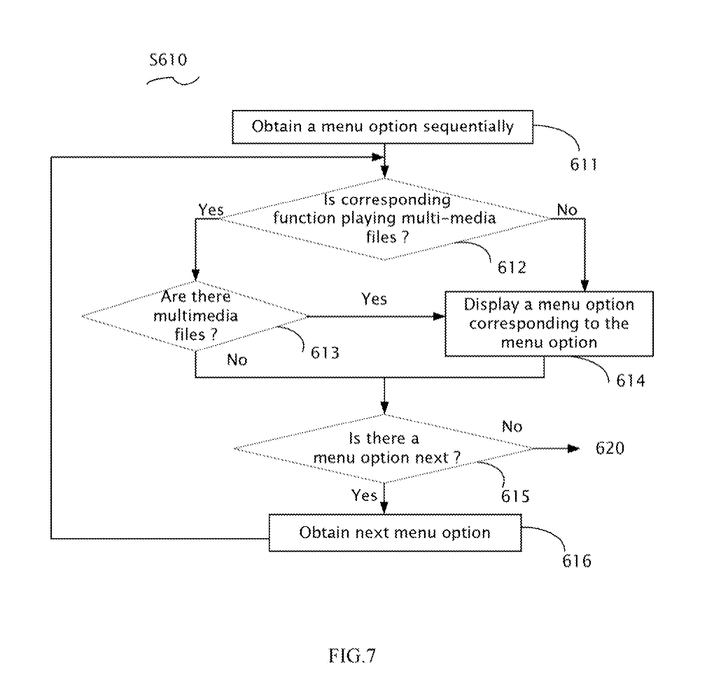

FIG. 7 is a detailed flowchart of the step 610 of the method of FIG. 6. Depending on the embodiment, certain of the steps described below may be removed, others may be added, and the sequence of steps may be altered.

In a step 611, the micro-processing unit 201 obtains one menu option sequentially from the preset menu options table.

In a decision step 612, the micro-processing unit 201 further determines if the function corresponding to the selected menu option is playing multimedia files. In other words, the micro-processing unit 201 determines if the function is one of the multimedia play functions. If the function is one of the multimedia play functions, the method continues to a decision step 613. If the function is not one of the multimedia play functions, the method continues to a step 614.

In the decision step 613, the micro-processing unit 201 determines if there are multimedia files in the memory 209. If there are multimedia files in the memory 209, the method continues to the step 614. If no multimedia files exist in the memory 209, the method continues to a decision step 615.

In the step 614, the micro-processing unit 201 displays the menu options on the display unit 30 as shown in FIG. 5.

In the decision step 615, the processing unit 201 determines if there is another menu option. If there is another menu option, the method continues to a step 616. If there is not another menu option, the method continues to the step 620.

In the step 616, the processing unit 201 obtains another menu option, and the method continues to the step 612.

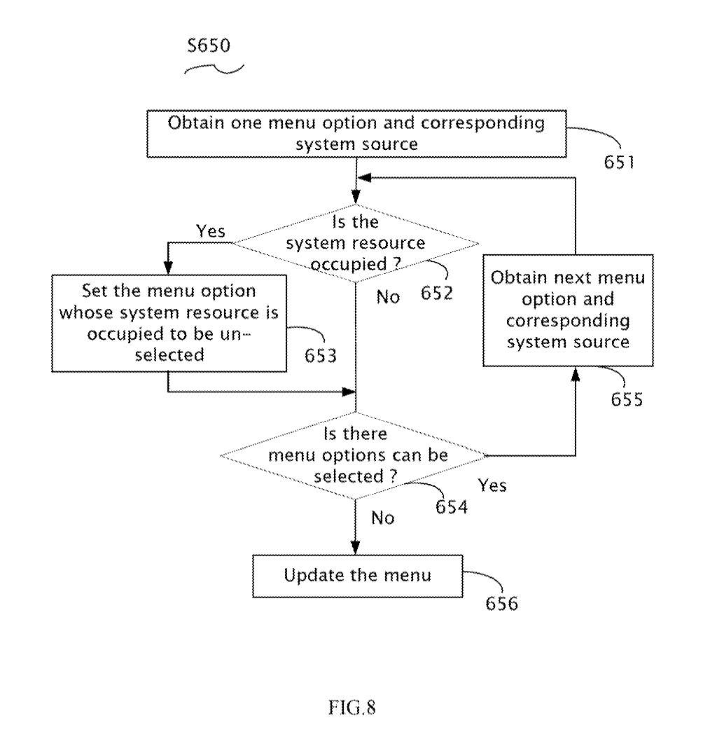

FIG. 8 is a detailed flowchart of the step 650 of the method of FIG. 6. Depending on the embodiment, certain of the steps described below may be removed, others may be added, and the sequence of steps may be altered.

In the step 650, the digital photo frame 2 updates the menu according to the menu options the user has selected.

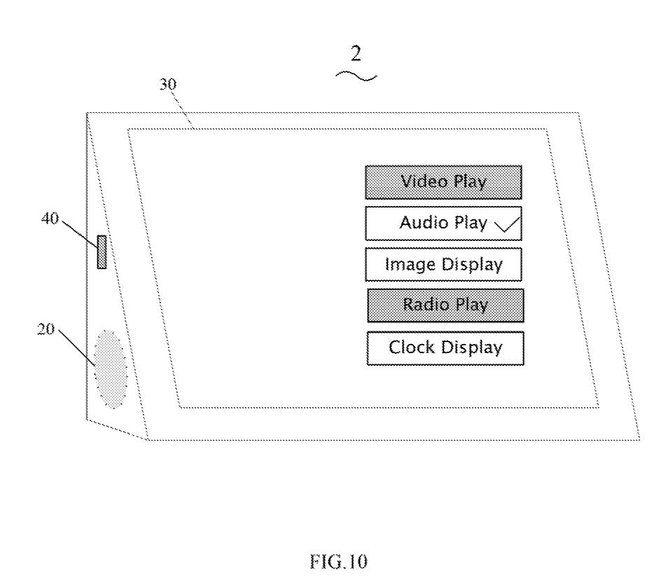

In a step 651, the processing unit 201 highlights the selected menu option, for example, the video play menu option as shown in FIG. 10, and determines the corresponding system resource needed.

Continuing to a decision step 652, the processing unit 201 determines if the system resource of the selected menu option is occupied. If the system resource is not occupied, the method continues to a decision step 654. If the system resource is occupied, the method continues to a step 653.

In the step 653, the determined system resource of the selected menu option is occupied so the selected menu option is set to be unavailable, and the method continues to the step 654.

In the step 654, the processing unit 201 determines if there are other menu options that can still be selected. If there are other menu options, the method continues to a step 655. If there are no other menu options, the method continues to a step 656.

In the step 655, the micro-processing unit 201 obtains another menu option and the corresponding system resource needed, and the method continues to the step 652.

In the step 656, the processing unit 201 updates the menu, and displays the updated menu.

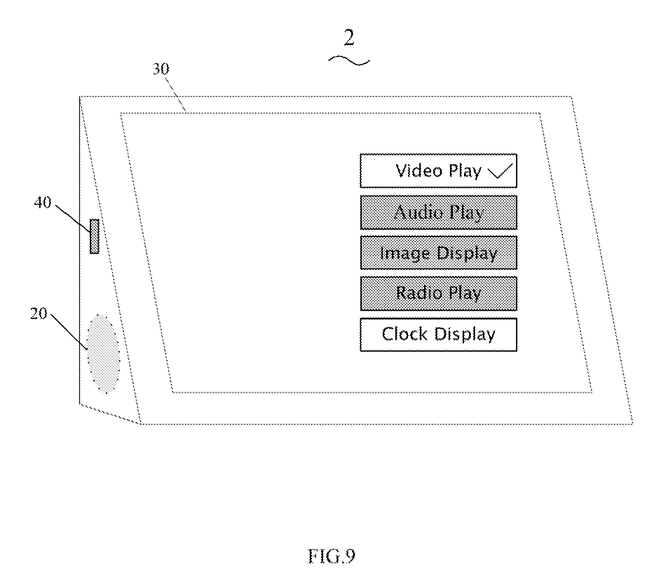

FIGS. 9 and 10 are isometric views of the digital photo frame 2 each illustrating, for exemplary purposes, the display state when one of the menu options of the menu illustrated in FIG. 5 is selected. In FIG. 9, a video play menu option has been selected and the menu shows the video play menu option with a selection confirmation mark such as a hook, via the display unit 30. According to the setting table, since the video play menu option is running, only a clock menu option is available for selection. The other menu options are unavailable for selection and are displayed as being unavailable with a non-optional indicator, for example, oblique lines. In FIG. 10, an audio play menu option has been selected and the menu shows the audio play menu option with a selection confirmation mark. According to the setting table, an image display menu option and a clock menu option are available for selection, while the other menu options are unavailable for selection and are displayed as being unavailable with a non-optional indicator. As an alternative, upon the condition that one of the menu options of the menu is selected, available menu options based on the current available system resources may be displayed on the menu, and unavailable menu options based on current unavailable system resources may be not displayed.

Although the embodiments have been specifically described, the embodiments are not to be construed as being limited thereto. Various changes or modifications may be made to the embodiments without departing from the scope and spirit of the invention.

What is claimed is:

1. A digital photo frame with menu options setting function, comprising:
a display unit;
a loudspeaker;
an input unit configured for receiving inputs;
a memory configured for storing a plurality of multimedia files, wherein each multimedia file corresponds to at least one of a plurality of menu options and system resources; each multimedia file is selected from a group consisting of a video file, an audio file, and an image file;
a multimedia processing unit configured for playing the plurality of multimedia files and outputting the plurality of multimedia files via the display unit and the loudspeaker; and
a micro-processing unit configured for controlling the multi-media processing unit to play multimedia files, outputting a menu of the plurality of menu options to the display unit, and generating a different menu in response to a selected operation on the menu and available system resources to prevent system resource occupation.

2. The digital photo frame of claim 1, wherein the menu comprises at least one of the plurality of menu options corresponding to the plurality of multimedia files that are stored in the memory; the micro-processing unit outputs the menu to the display unit.

3. The digital photo frame of claim 2, wherein the micro-processing unit is further configured to determine available system resources and corresponding menu options, and unavailable system resources and corresponding menu options.

4. The digital photo frame of claim 3, wherein upon the condition that one of the plurality of menu options of the menu is selected, available menu options based on the available system resources are displayed on the different menu, and unavailable menu options based on unavailable system resources are not displayed.

5. The digital photo frame of claim 3, wherein upon the condition that one of the plurality of menu options of the menu is selected, available menu options based on the available system resources are highlighted, and unavailable menu options based on unavailable system resources are indicated as being unavailable.

6. The digital photo frame of claim 1, wherein each menu option is assigned with a priority; at least one of the plurality of menu options is displayed on the display unit according to the priorities.

7. The digital photo frame of claim 1, further comprising a frequency modulation unit configured for receiving radio signals, wherein the menu options further comprises a radio play option.

8. The digital photo frame of claim 1, further comprising a time unit configured for supplying a system time to the digital photo frame, wherein the menu options further comprises a clock display option.

9. The digital photo frame of claim 1, wherein the input unit is selected from a group consisting of a touch sensing device and a key.

10. A method of setting menu options for a digital photo frame comprising a memory configured for storing a plurality of multimedia files, the method comprising:
outputting a menu of at least one of a plurality of menu options;
receiving inputs;
determining current available system resources and available menu options associated with multimedia file in response to a selected operation; and
generating a different menu on the menu to prevent system resource occupation.

11. The method of claim 10, wherein the method further comprises upon the condition that one of the plurality of menu options of the menu is selected, available menu options based on the current available system resources are displayed on the different menu, and unavailable menu options based on current unavailable system resources are not displayed.

12. The method of claim 10, wherein the method further comprises upon the condition that one of the plurality of menu options of the menu is selected, available menu options based on the current available system resources are highlighted, and unavailable menu options based on current unavailable system resources are indicated as being unavailable.

13. The method of claim 10, wherein the method further comprises recording the menu option selection and performing functions according to the recording.

14. The method of claim 10, wherein the method further comprises obtaining each of the plurality of menu options sequentially from a preset menu options table, and displaying one of the plurality of menu option.

15. The method of claim 14, wherein the method further comprises determining if there is another menu option according to the preset menu options table.

16. The method of claim 14, wherein the method further comprises upon the condition of the function corresponding to the menu option is playing a multimedia file or the function corresponding to the menu option is not playing a multimedia file, generating an interface including the plurality of menu options.

17. The method of claim 10, wherein the method further comprises displaying at least one of the plurality of menu options according to the multimedia files stored in the memory.

18. The method of claim 17, wherein the method further comprises obtaining all of the plurality of menu options available according to the multimedia files and generating all of the plurality of menu options.

19. The method of claim 17, wherein the method further comprises updating the menu in response to a selected operation on the menu.

20. The method of claim 17, wherein the method further comprises determining whether to end selecting menu options, and upon the condition of ending selecting menu options, recording the selection of at least one of the plurality of menu options and performing functions according to the recording.
